(19) United States
(12) Patent Application Publication
(10) Pub. No.: US 2010/0222481 A1
(43) Pub. Date: Sep. 2, 2010

(54) PRODUCT AND METHOD FOR CREATING AN ACTIVE CAPPING LAYER ACROSS SURFACES OF CONTAMINATED SEDIMENTS

(75) Inventors: Joseph Jersak, Ystad (SE); Tore Lundh, Sandefijord (NO)

Correspondence Address: VOLPE AND KOENIG, P.C., UNITED PLAZA, 30 SOUTH 17TH STREET, PHILADELPHIA, PA, 19103, US

(73) Assignee: BIOLOGGE AS, Sandefijord (NO)

(21) Appl. No.: 12/678,789

(22) PCT Filed: Sep. 18, 2008
(86) PCT No.: PCT/NO08/00338

§ 371 Date: May 7, 2010

(30) Foreign Application Priority Data
Sep. 18, 2007 (NO) 20074750

(51) Int. Cl. C09D 1/00

(52) U.S. Cl. 524/413; 106/204.01; 106/205.9; 106/287.1; 106/287.17; 106/287.18; 106/287.19; 106/287.32; 524/435; 524/436; 524/437

(57) ABSTRACT

A product is used in creating an active capping layer across submerged (and optionally exposed) surfaces of contaminated sediment, with the product including multiple, dry particles composed of variable types and amounts of inert material, reactive material and binding material. To create optimal characteristics for controlled and relatively rapid settling through a water column, the dry particles can selectively comprise different sizes, size gradations and shapes (as a function of procedures for manufacturing and processing) as well as different density, or specific gravity (as a function of optionally including relatively very dense minerals). The dry particles are manufactured by implementing the sequential steps of material mixing into a flowable paste, paste drying, crushing and optionally sieving.

### 1. BACKGROUND OF THE INVENTION

### 1a. Approaches for Managing Contaminated Sediments

Sediments occurring in many of the world's aquatic environments, including Norwegian fjords, harbors and shipyard areas, are impacted by a variety of organic and/or heavy to metal contaminants. Organic contaminants can include TBT, dioxins, PCBs, PAHs and/or other petroleum products whereas heavy metals can include Pb, Cu, Cr, Cd, Hg and others. In many locations, concentrations of one or more of these sediment contaminants can pose unacceptable health risks to humans and/or ecological receptors. The most direct approach for effectively lowering these risks to acceptable levels is to remediate the offending sediment contaminants.

A variety of in place (in situ) and remote (ex situ) methods exist for remediating (managing) contaminated sediments, including removal, treatment, capping and natural recovery. The most appropriate method(s) for use at a given site will vary, depending on site and sediment conditions, remediation goals, costs and other factors.

In situ approaches for managing contaminated sediments and the risks they pose—in situ capping and in situ treatment, in particular—are rapidly gaining national and international favor. Increased positive recognition of in situ capping and treatment is likely due to the advantages of these two approaches (relatively lower cost, lower environmental impact during implementation and ability to rapidly and significantly reduce risks), in combination with the recognized drawbacks to other management approaches (e.g. high costs associated with removal and slow rates associated with natural recovery).

In situ capping involves covering contaminated sediment in place with one or more clean materials. In situ capping is typically conducted for the purpose of providing a barrier between sediment-borne contaminants and potential ecological and/or human receptors occurring in the overlying aquatic ecosystem, including benthic organisms living in bottom substrates. Materials used to cap contaminated sediments can be either inert or chemically/biologically reactive in character, and often comprise earthen materials, engineered materials or combinations thereof. Cap designs can range from relatively simple (e.g. a “monolayer” of a single material, like natural, quartz-rich sand) to relatively complex (e.g. a “composite cap” comprised of multiple materials used in various configurations). The barrier formed by the cap can intentionally be relatively permeable or impermeable in character, depending on attributes of materials included in the design. Furthermore, the contaminated sediment to be capped may comprise naturally deposited sediment, dredged sediment re-deposited in a new underwater location or combinations thereof.

In situ treatment involves physically incorporating one or more reactive materials directly into the contaminated sediment mass for the purpose of stimulating or enhancing biological and/or chemical processes that bring about an in-place reduction in contaminant mass, toxicity, solubility and/or mobility.

In situ capping and in situ treatment can both be appropriate methods for use at many impacted sites, and both have been used successfully at the field scale. Nevertheless, many more field-scale capping projects have been completed to date than have treatment projects, for various reasons. Consequently, collective knowledge and experience related to designing and placing sediment caps in a variety of aquatic settings is considerably more extensive, such that the theoretical and practical aspects of the overall “science of capping” are arguably more mature than theoretical and practical aspects of in situ treatment. Because of these recognized and significant differences in the development of capping over treatment, regulatory and related governing bodies tend to view capping as a more viable and “acceptable” method for managing sediment-related risks in place, at least at this point in time.

### 1b. Conventional Versus Active Sediment Caps

In situ sediment caps can generally be categorized as either “conventional” or “active” caps, depending on the relative reactivity of the capping material used.

Conventional sediment capping involves covering contaminated sediment with relatively inert (non-reactive) material like natural, quartz-rich sand (typically referred to herein as “sand”), gravel and/or geotextiles, often for the purpose of isolating sediment contaminants—including upward-migrating contaminants—from potential receptors, including benthic organisms.

Most conventional caps are relatively permeable in character, largely because of the dominant use of granular materials (sand and/or gravel) for the construction of such caps. However, some conventional caps are, by design, relatively impermeable, by virtue of inclusion of membrane liners and/or very fine-grained mineral (e.g. clay) components within the cap design. Relatively impermeable sediment caps are sometimes referred to as “hydraulic barriers” and can be considered a sub-category of conventional caps.

Active sediment capping involves covering contaminated sediment with chemically and/or biologically reactive material for the purpose of treating sediment-borne contaminants. Like in situ treatment, contaminant treatment within the context of active capping generally involves bringing about a reduction in contaminant mass, toxicity, solubility and/or mobility. However, unlike in situ treatment, the “zone of treatment” for active capping occurs within the capping layer itself rather than within the underlying sediment mass. That is, in order for active capping layers to be effective, sediment-borne contaminants must first migrate up into the active capping layer, in one or more forms (i.e. dissolved phases and/or particle-bound phases). Little to no “passive” contaminant treatment is typically expected to occur within the sediment mass beneath active caps.

The specific process or processes by which contaminant treatment occurs through active capping (e.g. biodegradation, decreased solubility due to increased contaminant sorption or exchange to reactive organic or mineral solid phases, etc.) depends on the type of reactive material included as well as the mobilized contaminant(s) targeted for treatment. A non-exhaustive but fairly representative listing of recognized reactive materials that are more-or-less proven for use within the context of in situ active capping and/or in situ treatment is provided in Table 1. Use of additional or different reactive materials for treating other contaminants (e.g. phosphorous) is also described in Table 2.

TABLE 1
Treatment materials for use in situ active capping and/or in situ treatment.

| | Treatment process (including treatment material [underlined], when noted) | | |
|---|---|---|---|
| | | | Non microbial-driven |
| | Microbial driven | | Sorption, exchange (reduces |
| Contaminant of | Bioremediation (reduces mass | Reductive dechlorination (reduces | solubility and/or contaminant |
| concern | through degradation) | mass, toxicity) | concentrations in pore waters) |
| Petroleum | No amendments (Miralles et | | |
| hydrocarbons | al., 2007) | | |
| (aliphatics) | Review (Rockne & Reddy, | | |
| | 2003) | | |
| | Calcium nitrate (Golder, 2003) | | |
| | No amendments (Coates et al., | | |
| | 1997) | | |
| | Various nutrients, electron | | |
| | acceptors (Mitchell et al., | | |
| | 2000) | | |
| Polycyclic | Aqueous O₂, nutrients (Hyun | | Activated carbon (Werner et |
| aromatic | et al., 2005) | | al., 2005) |
| hydrocarbons | Gypsum (Rothermich et al., | | Activated carbon |
| (PAHs) | 2002) | | (Zimmerman et al., 2005) |
| | Aqueous sulfate, nitrate | | Activated carbon (Ghosh et |
| | (Rockne & Makkar, 2001) | | al., 2004) |
| | Calcium nitrate (Golder, 2003) | | |
| | No amendments (Coates et al., | | |
| | 1997) | | |
| | Various nutrients, electron | | |
| | acceptors (Mitchell et al., | | |
| | 2000) | | |
| Polychlorinated | | ZVI (Mikszewski, 2004) | Activated carbon (Werner et |
| biphenyls (PCBs) | | ZVI (Lowry & Johnson, 2004) | al., 2005) |
| | | ZVI (Gardner et al., 2004) | Activated carbon |
| | | Review (Field, 2001) | (Zimmerman et al., 2005) |
| | | Review (Rockne & Reddy, 2003) | Activated carbon (Ghosh et |
| | | | al., 2004) |
| Dioxins | | “Sludge cake” as OC source (Kao | Activated carbon and other |
| | | et al., 2001) | organic sorbents (no |
| | | “Haloprimer” (Haagblom, 2002) | specific reference found - |
| | | Review (Field 2001) | rather the “general belief” of |
| | | | researchers that sorptive |
| | | | behavior similar to that of |
| | | | PCBs) |
| Other | DDT treatment: ZVI (Eggen | | TCB, TCE treatment: |
| contaminants | and Majcherczyk, 2006) | | organic shales (Gullick & |
| | | | Weber, 2001) |
| Tributyltin (TBT) | Possible degradation through | | Activated carbon (Messing |
| | aerobic processes? | | et al., 1997; Layman's |
| | | | report, 2005; Envisan, 2005 |
| | | | a, b) |
| Metals | | | Zeolite for Pb (Jacobs & |
| | | | Forstner, 1999) |
| | | | Zeolite for Fe, Mn (Jacobs |
| | | | & Waite, 2003) |
| | | | Apatite (Crannell et al, |
| | | | 2004) |
| | | | Activated carbon for Hg |
| | | | (Millward et al., 2005) |
| | | | Me-S precip. (no specific |
| | | | reference) |
| | | | ZVI (ITRC, 2005) |

Virtually all active sediment caps are, by design, at least somewhat permeable. In concept, active sediment caps are generally analogous to “permeable reactive barriers”, or PRBs, which are commonly used for in-situ treatment of contaminants contained within flowing ground waters.

Both conventional and active capping can be appropriate techniques for effectively managing contaminated sediments in place. The choice of which technique to use at a given site will depend on a variety of factors, including the contaminants present, sediment and site conditions, project goals and objectives, costs and other factors.

To date, many more conventional capping projects have been completed on a field scale than active capping projects, for various reasons. Thus, similar to the immaturity of in situ treatment relative to in situ capping (in general), active capping significantly lags behind conventional capping in terms of experience and theoretical/practical development. Regardless, interest in active capping continues to grow, both in Norway and abroad, because active caps are believed to offer several advantages over conventional caps:
More effective (provides greater chemical isolation) than conventional caps.
Reduce long-term contamination of cap, thus extending life span of cap.
Ability to address multiple contaminants.
Inclusion of active materials may reduce the overall cap thickness needed for comparable performance, thus reducing encroachment into the overlying water column as well as reducing overall project costs.
Should encourage a greater degree of biodegradation of some organic contaminants immobilized within the cap.

Perhaps the most high-profile example of active sediment capping on a field scale is a demonstration project conducted on the Anacostia River, Washington D.C., U.S.A. This project, occurring from 2002-07, involved evaluating the placement and long-term performance of selected products or materials designed to treat or otherwise control contaminant migration through various processes. For reference, significant technical information is available on this project and can be found on the web at: http://www.hsrc-ssw.org/ana-index.html

### 2. SUMMARY OF THE INVENTION

### 2a. General Description of the Product According to the Invention

The invention relates to a product that, in its initial form (prior to placement into water), occurs as relatively small (typically 0.5 to 4 cm equivalent diameter), relatively dry and irregularly shaped (sub-angular to plate-like) solid particles. Each dry particle is composed of three different materials which are more-or-less evenly distributed spatially throughout the mass of each particle. The three materials, which can comprise variable percentages of the dry particles by mass and/or volume, consist of the following: an inert material; a reactive material; and a binding material. Furthermore, the three materials are different from one another, both in composition and function.

The inert material collectively comprises one or more relatively non-reactive (inert) minerals. The inert material is typically fine-grained in character, but can be coarser grained as needed. The primary function of the inert material is to serve as the dominant particle matrix, providing mass, volume and density to the dry particles.

The reactive material collectively comprises one or more minerals, naturally occurring materials and/or processed materials that are each, in their own way, chemically and/or biologically reactive. The reactive material can occur in either solid or liquid form, with solid minerals or materials occurring in a range of size fractions and/or particle densities. The primary function of the reactive material is to render the product, once placed, “active” and thus appropriate for use as an active capping material, as generally described in Section 1b.

The binding material collectively comprises one or more variably sized processed materials that are organic and/or inorganic in character. The binding material can occur in either solid or liquid form, with solid material occurring in a range of size fractions. The primary function of the binding material is to assist in establishing and maintaining the overall integrity (physical form and strength) of the individual dry particles, above and beyond that integrity imparted to each dry particle by virtue of characteristics (e.g. cohesive properties) inherent to the co-occurring materials.

Additional details related to preferred embodiments of the dry product are provided in Section 3a.

### 2b. General Description of the Procedure for Manufacturing the Dry Particles According to the Invention

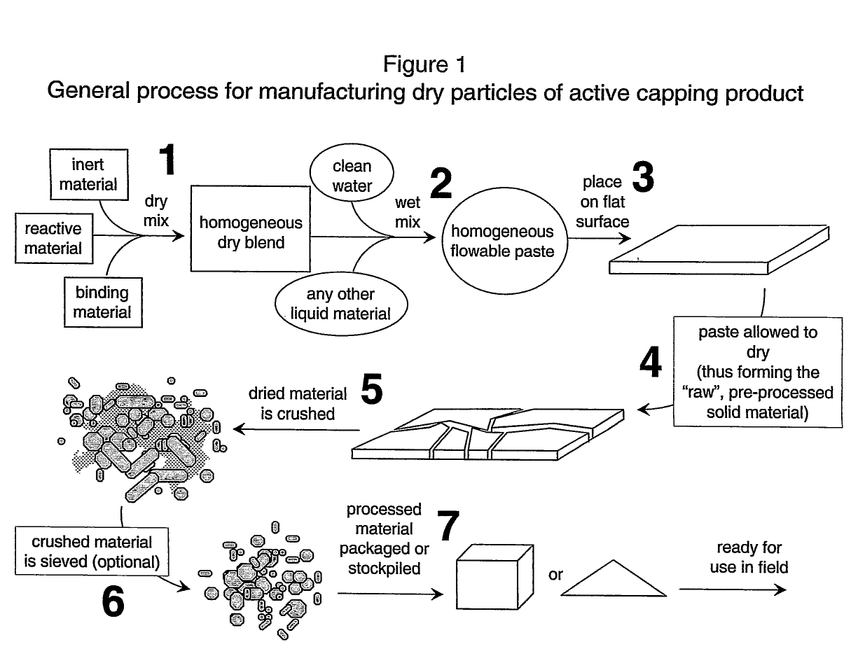

The general procedure for manufacturing the dry particles is described below, in step-wise fashion (Steps 1 through 7). A generalized, graphical depiction of this procedure is also provided in FIG. 1. Additional details related to preferred procedures for manufacturing dry particles on a large (project) scale are provided in Section 3b.
1. Appropriate quantities of selected inert, reactive and binding materials (all materials in dry form) are physically mixed together into a compositionally homogenous, dry blend.
2. The dry blend of materials is then physically mixed together with an appropriate quantity of clean water as well as quantities of selected reactive material (in liquid form, if present) plus selected binding material (in liquid form, if present) for the purpose of forming a compositionally homogeneous and flowable paste. The clean water used for preparation of the paste may be fresh, brackish or full-strength seawater, depending on desired product characteristics, the target aquatic environment for product use and other factors.
3. The paste is then placed onto a flat surface, in a manner that maximizes paste surface area while maintaining a paste thickness of approximately 1 to 2 cm.
4. The paste is then allowed to dry by one of several means, or by a combination of means. This is perhaps the most critical step in the overall procedure for particle manufacture in that it forms the “raw” solid material to be subsequently processed.
5. Once dried to an adequate state, the dried material—which typically forms relatively large and flat, “plate-like” masses—is then physically crushed into smaller-sized masses by one of several means. This is also a critical step in the procedure for particle manufacture in that it reduces the large, dried masses of raw, dried product into smaller (and more physically manageable) masses.
6. Once crushed to an adequate state, the material may then be optionally partitioned into selected particle size fractions or size-fraction ranges by mechanical sieving.
7. Masses of the dry particles may then either be packaged into water-resistant bags or stockpiled in bulk, in a manner that protects the bulk material from contact with water.

### 2c. General Description of a Typical Method for Use of the Dry Particles According to the Invention

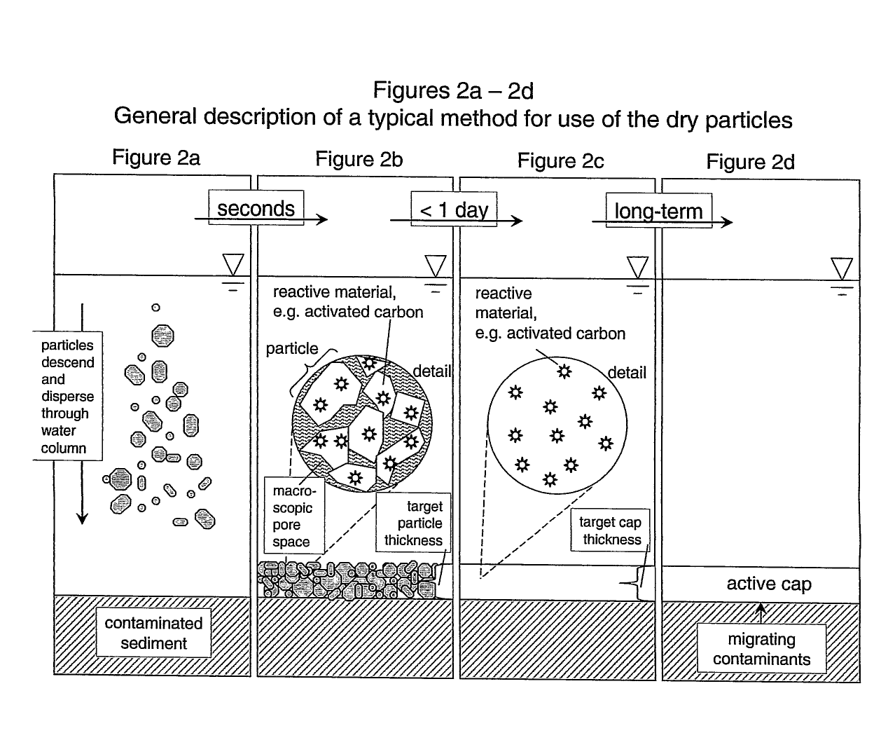

A typical method for use of the above-described dry particles for the purpose of creating an active sediment cap is described below, in chronological order. A graphical depiction for typical product use is also provided in FIGS. 2a through 2d. Additional details related to preferred methods for use of the dry particles for creating active caps are provided in Section 3c.
Using appropriate equipment and techniques for bulk-material handling, large masses of the dry particles are placed through the water column (of a fresh, brackish or full-strength seawater environment), at a position located somewhere above the submerged sediment surface. Some degree of lateral dispersion of the particle mass occurs during descent through the water column, primarily as a function of water depth and current flow, if present (FIG. 2a).
During the descent and dispersion phases of product placement, the particles maintain their overall integrity such that, once deposited or settled across the target sediment surface, a layer of discrete particles of some target total thickness is created (FIG. 2b). Significant macroscopic pore space occurs between the particles comprising the deposited layer (FIG. 2b, detail).
Within a relatively short period of time following placement of the layer of particles (typically much less than one day), each particle comprising the deposited layer becomes saturated with surrounding waters, mostly pore waters occurring in the adjacent macroscopic spaces. At the point of complete or near-complete saturation, the particles loose their overall integrity and disaggregate, or crumble, in-place. This process results in an in-filling of the initial macroscopic pore spaces with crumbling particle material, a complete to near-complete loss of macroscopic pore space (FIG. 2c, detail) and, ultimately, the formation of a continuous and compositionally homogenous capping layer overtop the target sediment surface (FIG. 2c). The active capping layer retains some degree of interconnected pore space. Now, however, pore spaces are mainly microscopic in size, with pore-size gradation and spatial distribution within the formed layer being functions of settling and packing of the component materials rather than functions of the initial discrete particles.
Because the now-formed capping layer is compositionally homogeneous, the reactive material included therein is uniformly distributed, both laterally and vertically, throughout the entire layer. Construction of the active sediment cap is now complete, and the cap would then function as intended over the long term (FIG. 2d), as generally described in Section 1b.
For clarification, the active capping layer formed through the process described above would specifically provide for long-term, enhanced chemical isolation of sediment-borne contaminants, which is one of the primary specific functions of any sediment cap. Other capping materials or capping layers would then likely be included to provide for other functions within the overall cap design, e.g. an overlying layer of large stones to provide for erosion protection, and/or an overlying layer of organic-rich material to provide for clean benthic habitat.

### 3. DETAILED DESCRIPTION OF PREFERRED EMBODIMENTS OF THE INVENTION

### 3a. Product Composition and Attributes

According to the invention:
The dry particles preferably occur as irregularly shaped, sub-angular to plate-like solid masses of variable sizes. Particle sizes are preferably graded and range from approximately 0.5 cm in equivalent diameter up to approximately 4 cm in equivalent diameter. Size gradation of the dry particles is mainly a function of the method of product manufacture and processing, as described in Sections 2b and 3b.
Density, or specific gravity, of the dry particles preferably ranges from approximately 2 g/cm³ up to 4+g/cm³. The specific gravity of the dry particles is mainly a function of product composition and, to a lesser extent, moisture content.
Unit weight (bulk density) of a mass of dry particles preferably ranges from approximately 80 pounds per cubic foot (lbs/ft³) up to approximately 150 lbs/ft³. Dry unit weight is primarily a function of product composition, moisture content, particle size gradation, and the nature/extent of three-dimensional settling or packing of the particles.
Permeability, or saturated hydraulic conductivity, of the active capping layer formed from the particles preferably ranges from on the order of 10⁻² cm/s up to on the order of 10⁻⁸ cm/s. Permeability of the active capping layer is a function of grain size distribution of materials comprising the product; salinity of the permeating waters; the extent of in-place consolidation of the active capping layer; and other factors.

According to the invention, the inert material in the product preferably comprises, but may not be limited to:
Clay to silt-sized fractions of one or more of the following relatively non-reactive and relatively dense minerals: bentonite (of a sodium- and/or calcium-rich character); dolomite; calcite; barite; ilmenite; hypersthene; magnetite and/or olivine. Because of its unique and well-known “shrink-swell” attributes, bentonite, in particular, may provide significant strength and integrity to the dry particles as a result of the drying and shrinking processes that occur as a paste containing this particular mineral dries out. Additionally, it is recognized that some minerals designated herein as relatively inert, e.g. dolomite and calcite, may in fact impart a relatively basic character to the material, which may, in turn, create higher-pH environments within pore waters that serve to promote precipitation and immobilization of some metals.
Alternatively, sand-sized fractions of one or more of the following relatively non-reactive and relatively dense minerals: quartz-rich sand (containing a mixed-mineral assemblage); dolomite; calcite; ilmenite; hypersthene; magnetite and/or olivine. Potential justifications for including relatively coarser-grained inert material instead of relatively finer-grained inert material are briefly discussed in Section 3c.

Some inert materials may, depending on the conditions, also be reactive. One such material is olivine.

According to the invention, the reactive material in the product preferably comprises one or more reactive materials occurring in solid and/or liquid form.
Reactive materials in solid form preferably include, but may not be limited to, the following, which occur in a range of size fractions (clay to sand-sized) and in a range of particle densities:
   Activated carbon; coke; organic-rich topsoil; organic-rich sediment; humus; apatite; zeolite; iron ore-rich material; organoclay; organic shale; lime; gypsum; elemental sulfur; bauxite; fish meal; zero-valent iron (ZVI) and/or oxides/hydroxyoxides of iron, manganese and/or aluminum.
   One or more commercially available products rich in nutrients and/or molecular oxygen may also or instead be included as the solid-phase reactive material.
Reactive materials in liquid form preferably include, but may not be limited to, the following materials:
   Biosurfactants; liquid fertilizer; hydrogen peroxide and/or potassium permanganate.
   One or more commercially available products rich in nutrients and/or molecular oxygen may also be included as the liquid-phase reactive material.
Multiple reactive materials, e.g. activated carbon plus Fe oxides plus nutrients, may optionally be included for simultaneous cap-based treatment of multiple, sediment-borne contaminants.

According to the invention, the binding material in the product preferably comprises one or more organic and/or inorganic binding materials.
Binding materials of an organic character, and occurring in solid or liquid phase, include, but may not be limited to: polyvinyl acetate; hydroxyethyl cellulose; guar gum and/or guar derivatives.
Binding materials of an inorganic character, and occurring in solid or liquid phases, include, but may not be limited to: glass fibers; gypsum and/or silicates of sodium, potassium or lithium.
In selected embodiments of the product, binding materials exclusively of an inorganic character may be selected for inclusion if concerns exist regarding the formation of highly anaerobic conditions and/or microbially generated gases within the active capping layer, one or both of which could be promoted through inclusion of organic binding material. Conversely, formation of highly anaerobic conditions within the active capping layer, as promoted through inclusion of organic binding material, may in fact provide for effective cap-based treatment of some mobilized metal species (through encouraging the precipitation and stability of metal-sulfide complexes within the solid phase).

### Example 1 of Product Composition and Attributes

In one example of the invention, the active capping product is designed to manage TBT-contaminated sediment occurring within a relatively low-energy, inner-harbor environment (average water depth approximately 6 m). In this example, the TBT contamination is managed (treated) by creating an active capping layer containing activated carbon. The specific treatment process involves sorption of migrating, dissolved-phase TBT to activated carbon surfaces contained within the active capping layer, which immobilizes the TBT. The active capping layer is also relatively low-permeability in character (˜10⁻⁷ cm/s), an attribute that, in addition to carbon sorption, assists in minimizing long-term TBT migration through the cap.

In addition to containing activated carbon (the reactive material), the product also contains a 50/50 blend of dolomite+bentonite (the inert materials) as well as polyvinyl acetate (the binding material).

Dry particles of the product range in size from 0.5 to 2.0 cm and have an average particle density of approximately 2.5 g/cm³. Larger and denser (and more rapidly settling) particles than this are not required because this is a relatively low-energy environment, and particles with these physical characteristics can be placed through the water column and across the seabottom in an adequate manner.

### Example 2 of Product Composition and Attributes

In another example of the invention, the active capping product is designed to manage petroleum-contaminated sediment occurring within a relatively high-energy, outer-harbor environment (average water depth approximately 20 m). In this example, petroleum contamination is managed (treated) by creating an active capping layer containing gypsum as well as N+P fertilizer. The specific treatment process involves enhancing the activity of indigenous populations of sulfate-reducing bacteria occurring within the active capping layer by adding abundant sulfate (i.e. provided by slow dissolution of gypsum into cap pore waters) in combination with major nutrients (soluble N+P) into the cap. As microbial activity within the cap increases as a result of adding these bioreactive materials, so does the biodegradation of migrating, dissolved-phase petroleum constituents (namely, aliphatic hydrocarbons and low-ring polycyclic aromatic hydrocarbons) within the active capping layer. The active capping layer displays moderate permeability (10⁴ to 10⁻⁵ cm/s).

In addition to containing gypsum and fertilizer (the reactive materials), the product also contains a 50/50 blend of barite+quartz-rich sand (the inert materials). Polyvinyl acetate is also included in the product (as a binding material). However, only a small amount of this organic binder is included because the treatment process is biotic in nature, and thus sensitive to influences that inclusion of abundant biodegradable organic binder may have on redox conditions within the active capping layer. The gypsum component, included mainly as a reactive material, also provides some particle-binding attributes.

Dry particles of the product range in size from 1.5 to 3.0 cm and have an average particle density of over 3 g/cm³. Such relatively large and dense (and rapidly settling) particles are required in order to create, with an appropriate level of control, an active capping layer across the seabottom in this high-energy environment.

### 3b. Processes for Manufacturing Dry Particles on a Large (Project) Scale

According to the invention:
Large and known quantities of dry as well as liquid material components comprising the flowable paste are preferably mixed together using commonly available equipment, such as a cement mixer. Other industrial-scale mixing equipment can also be used to prepare the paste.
The prepared paste is preferably dried by placing, or pouring, multiple, discrete mixer-loads of paste across large, flat surfaces located out-of-doors, whereby the paste dries naturally and relatively slowly, under ambient atmospheric conditions. This relatively passive and low-energy drying process results in the formation of relatively large, flat and dry, plate-like masses of “raw”, solid material.
Alternatively, the prepared paste is preferably dried by placing it onto a large conveyor belt that is passed through an industrial-scale oven. In this way, the paste is dried at a greatly accelerated rate and at a controlled temperature. This drying process also results in the formation of relatively large, flat and dry, plate-like masses of raw, solid material.
Alternatively, the prepared paste is preferably first dried naturally, to a target state of moisture content (stage 1 drying). Masses of the air-dried material are then placed onto a large conveyor belt and passed through an industrial-scale oven for final drying (stage 2 drying). Implementing such a two-stage drying process, with the second stage occurring at a significantly higher temperature, may impart added strength and integrity to the dry, solid product, depending on the materials contained therein.
The relatively large, flat and dry, predominantly plate-like masses formed through natural and/or accelerated drying are then preferably crushed into smaller-sized masses (sub-angular to plate-like in shape) using commonly available equipment, such as a quarry rock crusher. The extent of material crushing can be controlled and would largely depend on the size and size gradation of dry particles required for a given capping project.
As an optional, subsequent step, the crushed material is preferably sieved into various particle size fractions or size-fraction ranges of dry particles. This sieving step could be accomplished using commonly available equipment, such as a quarry sieve. Justification for implementing the optional step of post-crushing sieving of the dry material would be determined on a project-specific basis. If a sieving step is deemed necessary, the extent of sieving can be controlled and would largely depend on project-specific needs.
As an additional and optional, subsequent step, post-crushed or post-crushed+sieved material is preferably further dried, either naturally or using an industrial-scale oven, as described above. Implementing such an additional drying step may impart added strength and integrity to the dry particles, depending on the materials contained therein.
The finer-sized fractions of dried material generated through mechanical sieving of crushed material may not be appropriate for use as active capping material, due to potential challenges in adequate placing such relatively smaller (and relatively slow-settling) material. In such cases, the finer-sized material is preferably re-cycled by adding it as an additional dry component during preparation of the paste.

### Example 1 of a Process for Manufacturing Dry Particles

In one example of the invention, which is directly related to Example 1 under Section 3a, appropriate quantities of granular activated carbon, powdered dolomite and powdered bentonite are mixed together in a cement mixer. In a separate mixing tank, appropriate quantities of polyvinyl acetate plus seawater are mixed together. The solid (dry) and liquid materials are then both added into a second cement mixer and the materials are mixed together into a flowable paste. In preparing this product mix, the quantity of polyvinyl acetate used is not critical since the treatment process is abiotic in nature (that is, anaerobic conditions potentially encouraged by including significant quantities of biodegradable organic binder should not adversely affect this abiotic treatment [sorption] process).

Multiple mixer loads of the paste are prepared and poured onto a flat concrete floor for air drying. After approximately one week, the large, plate-like masses of now air-dried and cracked material is scooped up with a front-end loader and placed into a hopper that feeds a rock crusher, and the material is then crushed. Size fractions of less than 0.5 cm are retrieved and re-used in paste preparation. Size fractions of greater than 2.0 cm are re-crushed and re-sieved.

The 0.5 to 2.0 cm size fraction of sub-angular to plate-like solid material is then isolated and placed onto a large conveyor belt that passes continuously and slowly through an industrial-sized oven with the temperature set at 110° C. (total oven drying time approximately one hour). The now oven-dried particles are completed active capping product. The particles are off-loaded from the conveyor belt and stockpiled on a warehouse floor until the stockpiles can be transported, in covered dump trucks to the TBT-impacted sediment site and used in active capping.

### Example 2 of a Process for Manufacturing Dry Particles

In another example of the invention, which is directly related to Example 2 under Section 3a, appropriate quantities of powdered gypsum, powdered barite and quartz-rich sand are mixed together in a cement mixer. In a separate mixing tank, appropriate quantities of liquid N+P fertilizer, polyvinyl acetate and seawater are mixed together. The solid (dry) and liquid materials are then both added into a second cement mixer and the materials are mixed together into a flowable paste. Enough gypsum is incorporated into the product formulation to help maintain particle integrity during above-water handling and during water-column descent, but not so much that it precludes the particles, once placed across the seabottom, from disaggregating and transforming into a compositionally homogeneous active capping layer.

Multiple mixer loads of the flowable paste are prepared and placed directly onto a large conveyor belt that passes intermittently through an industrial-sized oven set at a temperature of 110° C. (total oven drying time approximately 24 hours). The large, plate-like masses of now oven-dried and cracked material are then offloaded directly into a hopper that feeds a rock crusher, and the material is then crushed. Size fractions of less than 1.5 cm are retrieved and re-used in paste preparation. Size fractions of greater than 3.0 cm are re-crushed and re-sieved.

The 1.5 to 3.0 cm size fraction of sub-angular to plate-like solid material, which is completed active capping product, is then isolated and packaged into multiple, water-resistant bags. The bags are then placed onto pallets and stacked in a warehouse until they are transported, via flatbed trailers, to the petroleum-impacted sediment site and used in active capping.

### 3c. Methods for Creating an Active Capping Layer Using the Dry Particles

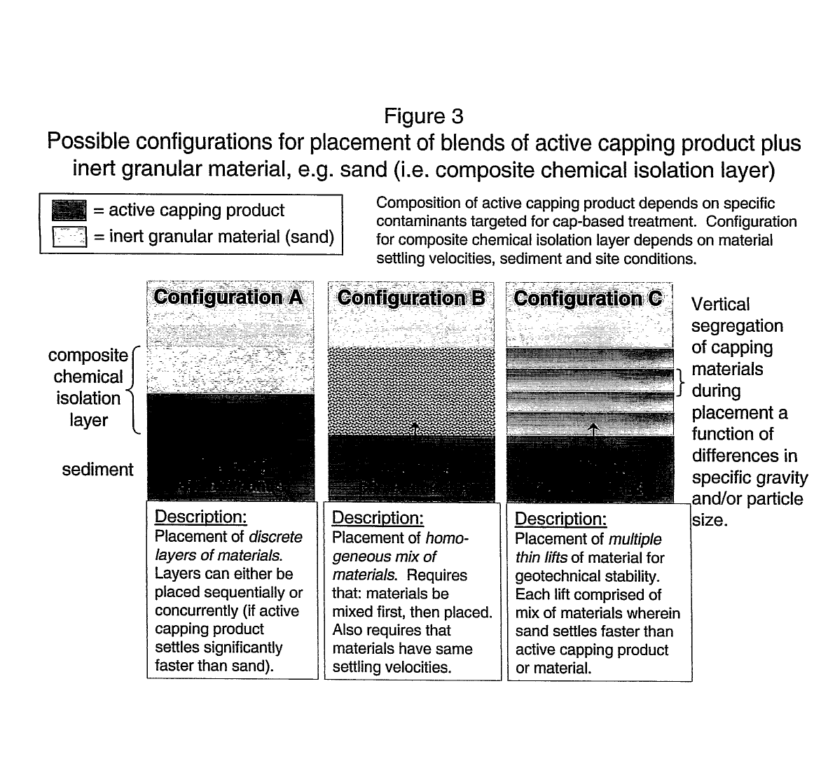

According to the invention:
The dry particles are preferably placed either as discrete quantities or in more-or-less continuous fashion, depending on chosen equipment, handling techniques and other factors. The rate at which masses of the dry particles descend (settle) through the water column, once placed, will depend on, among other factors, particle size as well as particle density (specific gravity). Larger particles will tend to settle faster than smaller particles of a similar density. Denser particles will tend to settle faster than less-dense particles of a similar size.
There exists the need to create an appropriate balance between adequate strength and integrity of the dry particles—during their bulk handling and placement through the water column—and the requirement for particle disaggregation and infilling of macroscopic pore space, once the layer of particles is deposited across the sediment surface. Key variables to consider towards achieving this balance include, but may not be limited to: material composition; the manufacture procedure (particularly the drying step); and site conditions, namely water depth and current flow.
The thickness of the final active capping layer depends on the quantity of dry particles placed across the sediment surface per unit area. Placement of relatively larger quantities of dry particles per unit area results in the formation of a relatively thicker active capping layer whereas placement of relatively smaller quantities results in a relatively thinner layer.
The active capping layer—that is, the “chemical isolation layer” of the overall sediment cap design—preferably comprises a monolayer of the active capping product. The total thickness of the active capping layer required will depend on project goals, effectiveness of the cap-based treatment process, sediment and site conditions, costs and other factors.
Alternatively, the active capping layer preferably comprise a physical mix of the active capping product plus relatively inert granular material, e.g. sand (thus forming a composite chemical isolation layer). Specifically, the active capping product may be combined with sand to form a composite chemical isolation layer of one of several physical configurations (e.g. FIG. 3).
   The specific configuration constructed will depend on various factors, including: intended functioning of the cap; sediment strength (e.g. low strength requires material placement in multiple thin lifts to maintain geotechnical stability); site conditions (e.g. water depth and current flow); method of cap construction used; and what is—and is not—possible in terms of material placement (based on the physical character and settling velocity of the active capping product or material [namely particle size and specific gravity] relative to those attributes of the sand material).
Additional conventional capping materials, such as sand and/or coarser particles (armoring), are preferably placed overtop the active capping layer, primarily for the purposes of providing appropriate habitat for benthic organisms and/or protecting the active cap from erosional forces that could cause a loss of the active capping material.
The permeability of the active capping layer depends on the grain size distribution of material comprising the layer (and comprising the initial dry particles); the presence and type of clay minerals included and salinity of the permeating water. A dominance of relatively coarse-grained material (e.g. sand-sized particles) would encourage the formation of a relatively permeable layer whereas a dominance of relatively very fine-grained material (especially phyllosilicate clay) would encourage the formation of a relatively less-permeable layer.
The active capping layer preferably comprises two or more discrete layers encompassing the overall cap design. The overall physical design and intended functioning of the active capping layer (physical composition; reactive material[s] incorporated; final thickness; permeability) depends on prevailing site conditions; sediment conditions; the contaminant(s) present and remedial goals for the capping project.
A composite chemical isolation layer specifically comprising a relatively discrete bottom layer of active capping product overlain by a relatively discrete layer of sand (FIG. 3, Configuration A) could be created by first mixing dry masses of the particles with dry masses of sand prior to placement. Because of their larger size and higher specific gravity, the dry product particles will naturally settle through the water column at a faster rate than the smaller and/or less-dense sand particles. This differential settling rate as a function of capping material type will naturally result in first the deposition of the product particles across the target sediment surface, followed by deposition of the sand particles overtop the product particles. This method for product use would result in the relatively cost-effective construction of a composite active capping layer.
Further to the controlled, differential-settling-rate concept described in the preceding paragraph: Two separate, discrete active capping layers, each containing a different type of reactive material, may be similarly created by including the different reactive materials in particles of variable size and-/or variable specific gravity. For example, reactive material “A” (e.g. nutrients) may be incorporated into larger, more-dense particles while reactive material “B” (e.g. activated carbon) is incorporated into smaller, less-dense particles. Masses of the two types of particles could first be mixed together, then placed as a single mass through the water column. The particles containing reactive material A would naturally settle (and deposit) at a faster rate than material B particles, thus allowing for the relatively cost-effective construction of an active capping bi-layer design. Additionally, yet a third material capping component—e.g. an inert sand, of even a less-dense and/or smaller particle size—could also be added with masses of material A and material B particles, thus allowing for the relatively cost-effective construction of the active capping bi-layer with a separate, discrete layer of sand deposited overtop the bi-layer.
Further to the controlled, differential-settling-rate concept described in the two preceding paragraphs: The settling rate of particles may also be controlled by controlling their shape, in addition to or instead of, controlling particle size and/or specific gravity. For example, flatter, more plate-like particles will tend to settle at a slower rate than rounder, more spheroidal-shaped particles.

### Example 1 of a Method for Creating an Active Capping Layer

In one example of the invention, which is directly related to Example 1 under Sections 3a and 3b, a composite (multi-layer) active sediment cap is designed and constructed for in situ management of the TBT-contaminated sediments. The composite cap design comprises a target 15 cm-thick basal layer of active capping product (containing activated carbon as the reactive material) covered by a target 15 cm-thick surficial layer of sand. The surficial sand layer is included to provide clean “replacement” habitat for benthic organisms. Given the relatively low-energy nature of this inner-harbor environment (low current), a surficial armoring layer overtop the sand layer is not necessary.

By virtue of its larger particle size (and despite similar material densities), the active capping product settles more rapidly through the water column than does the sand material. Thus, the procedure for cap construction first involves using an excavator to dry-mix appropriate bulk quantities of the active capping product together with bulk quantities of sand at a shore-based staging area. Masses of the mixed capping material are then transferred onto a material barge and transported to the equipment barge. Discrete quantities of the mixed capping material are then placed at the water surface using a clamshell bucket plus crane (parked on the equipment barge). Because of its faster settling character, the active capping product deposits first across the seabottom, followed by deposition of the relatively slower-settling sand material—thus forming two more-or-less separate layers of material.

Within approximately 24 hours following placement of the basal layer of particles of the reactive capping product, each particle saturates with seawater+extruded sediment pore waters and each particle disaggregates in-place. This results in an in-filling of macroscopic pore spaces with crumbling particle material and, ultimately, the formation of a compositionally homogeneous active capping layer (with a permeability of approximately 10⁻⁷ cm/s).

As a note, during field execution of the capping project, there is some spatial overlap between separate clamshell loads of material placed and, thus, a “perfectly discrete” layering of the two materials is not achieved. Regardless, it is determined that the final constructed cap is adequate for meeting project performance goals and thus provides for cost-effective in-situ management of the TBT-contaminated sediments.

### Example 2 of a Method for Creating an Active Capping Layer

In another example of the invention, which is directly related to Example 2 under Sections 3a and 3b, a composite (multi-layer) active sediment cap is designed and constructed for in situ management of petroleum-contaminated sediments. The composite cap design comprises—from bottom to top—a target 15 cm-thick basal layer of active capping product (containing gypsum and N+P fertilizer as the reactive materials), a target 15 cm-thick layer of sand (as a filter layer) and a target 15 cm-thick surficial layer of approximately 3 cm-diameter armoring stone (to provide for erosion protection within this relatively high-energy, outer-harbor environment).

Similar to Example 1, the active capping product settles much faster than the sand material, by virtue of its much larger particle size and higher particle density. Such differential settling attributes could potentially allow for constructing two relatively discrete capping layers by placing mixed material at the water surface (also similar to Example 1). However, a different construction approach for placing the bottom two layers is used in this example for two reasons: (a) current flow within this higher-energy environment is expected to significantly and selectively disperse the much smaller/lighter sand material during its descent through the water column, thus making controlled placement of the sand component (when added at the water surface) a significant challenge; and (b) as opposed to Example 1, performance objectives for this project call for tighter control (i.e. lower tolerance) with respect to constructing discrete layers of the cap according to specifications.

For the above reasons, the following approach to cap construction is considered to be the most practical and cost-effective: First, the basal layer of active capping product is placed at the water surface and across the entire seabottom area using a continuous-feed conveyor (parked on the equipment barge and supplied with product from the material barge). Second, the overlying layer of sand is constructed by creating a sand-seawater slurry and conveying the material across the entire seabottom area by tremie piping the slurried material down through the water column, to within a couple meters of the seabottom (at which time the sand only descends within the open water a short distance, which greatly improves placement precision and accuracy). And third, the final/surficial armor layer is placed over the sand layer using the same equipment and method used to place the basal layer of active product.

As a note, the process for formation of the basal active capping layer in Example 2 occurs in the same manner as the process described in Example 1 (i.e. particle dissaggregation, in-filling of macroscopic pores and ultimately, formation of a compositionally homogenous active capping layer). However, in the case of Example 2, several days (rather than 24 hours) are required for the gypsum-rich active capping particles to disaggregate and in-fill macropore spaces. Also, once the active capping layer for Example 2 is formed, its permeability is two to three orders of magnitude higher than that for the active capping layer in Example 1 as a result of the relatively higher permeability inherently associated with barite (when compared to bentonite-bearing material) coupled with the significant sand content of the active capping layer in Example 2.

### 4. EXISTING PRODUCTS OR MATERIALS AND METHODS FOR CREATING ACTIVE SEDIMENT CAPS AND COMPARISONS WITH THE INVENTION

### 4a. Existing Products or Materials and Methods

A number of products or materials have already been specifically developed for, or additionally used for, creating active sediment caps ¹. A non-exhaustive but fairly representative summary listing of these existing products or materials and methods is provided in Table 2. ¹ For the purposes of this document, active capping “products” can typically be defined as manufactured or engineered products typically comprised of two or more naturally occurring and/or synthetic materials that are physically connected in some fashion. In contrast, active capping “materials” can typically be defined as naturally occurring or processed materials (e.g. residual by products) of a non-manufactured and non-engineered nature. Active capping materials would include simple physical combinations, or blends, of masses of inert material (e.g. sand) with masses of reactive material (e.g. granular activated carbon, GAC).

Generally speaking, most of the products or materials listed in Table 2 are intended for use in forming only the chemical isolation layer portion of a typical active sediment cap design: other, inert materials (e.g. sands, stones, geotextiles, etc.) are often also included in the overall cap design to serve additional functions (e.g. erosion control, habitat enhancement, etc.). Furthermore, the listed products or materials vary widely with respect to the extent to which each has been used on a field scale.

### Additional Note Regarding Products for In Situ Management of Sediment Contaminants:

Although not developed specifically for use as active capping products, other products have been developed that are similar, in some respects, to the invention.

One such known product is the SediMite technology recently developed in the USA by Charles Menzie and associates. Following is a brief summary of various aspects of the product, as reported in Menzie et al., 2007:

### Intended Use or Function of the Product:

Product intended as a mechanism for delivering reactive treatment materials (e.g. activated carbon, ZVI, Fe oxide, calcium carbonate, etc.) to a submerged sediment surface.
Product use would serve as a type of in situ sediment treatment (not active capping), whereby bioturbating benthic organisms would naturally, over time, physically incorporate the delivered reactive treatment materials to some depth within the sediment mass (effectively precluding the need for injection or mechanical mixing as a means for material incorporation).
Using this product, in situ treatment would be accomplished through a reduction in the concentration or bioavailability of various organic and/or metallic contaminants within the sediment mass through processes of chemical reaction or sorption.

### Composition and Physical Character of the Product:

Solid, pellet-shaped “agglomerates”, or particles (apparently gravel-sized or slightly larger).
Pellets composed of primary binder(s); secondary binder(s), to reduce friability; weighting agent(s); treatment agent(s), e.g. powdered activated carbon; and coating(s).

### Method of Product Manufacture:

Variable (pressure extrusion; tumble/growth; heat/sintering or atomization). Pressure extrusion appears to be the preferred method.

### Method for Placement of Product:

One proposed method is through use of a particle broadcaster for above-water placement.

### Patent Status of Product:

Unknown.

TABLE 2
Representative summary of existing products or materials and methods for creating active sediment caps.

| | | | General method of manufacture | General description of method for |
|---|---|---|---|---|
| | | General composition and | or preparation (primarily | use in creating an active |
| Name of product or material | | physical character | for products) | sediment cap (including placement) |
| Products | 1. AquaBlok ® | Manufactured composite particles | According to U.S. Pat. | Masses of composite particles are |
| | products | resembling small, semi-spherical | No. 5,897,946, “. . . the | placed into water using commonly |
| | (from AquaBlok, | stones. Particles are typically | composite particles are | available construction equipment, |
| | Ltd). | granular in size, i.e. gravel | manufactured by compressing the | then settle down to, and deposit |
| | | size and larger. | sealant layer against the core.” | across, the submerged sediment |
| | | Composite particles can be well | Alternatively, “. . . the | surface. |
| | | to poorly graded. | composite particles are | Can also be placed across exposed |
| | | Composite particles are of | manufactured by coating the | (dry) sediment surfaces. |
| | | relatively high specific gravity. | core with water and then | If particles' sealant layer |
| | | Particles are air-dry and | applying the sealant layer | dominated by certain clay |
| | | comprised of a central solid | around the coated core.” | materials: clay component |
| | | core (often stone aggregate) | | hydrates and swells, resulting in |
| | | surrounded by a “sealant layer”. | | formation of an expanded, |
| | | Sealant layer typically comprised | | relatively homogeneous and |
| | | of clay materials (often | | impermeable cap, which functions |
| | | bentonite) plus organic polymers. | | as hydraulic barrier. |
| | | Sealant layer may instead be | | If particles' sealant layer |
| | | comprised largely of sand-sized | | dominated by sand-sized material: |
| | | materials. | | particles more-or-less |
| | | Materials included in sealant | | disaggregate (rather than swell) |
| | | layer may be inert, active or | | and a more permeable cap is |
| | | combinations thereof. | | formed. |
| | | Different products available, | | Regardless of cap permeability, |
| | | with respect to composition and | | product can be made “active” by |
| | | intended function. | | including active treatment |
| | | Typical forms of the product | | materials as part of sealant |
| | | serve as a low-permeability | | layer. |
| | | (and relatively inert) hydraulic | | Specific contaminants treated by |
| | | barrier. | | active cap (organics, metals, |
| | | Other forms of the product | | etc.) are a function of the |
| | | include active materials (e.g. | | reactive materials included in |
| | | ZVI, activated carbon, sulfur | | the product. |
| | | and/or others) in the sealant | | |
| | | layer. | | |
| | | Active capping products can also | | |
| | | vary in permeability as a | | |
| | | function of clay content and | | |
| | | other factors. | | |
| | 2. Reactive Core | Manufactured, permeable and | Described in detail in | Reactive mats are typically |
| | Mat ® products | carpet-like composite mat, ~2-3 | published patent applications. | placed (rolled out) across, and |
| | (from CETCO). | cm thick, consisting of reactive | | anchored to, submerged sediment |
| | | material(s) encapsulated in a | | surfaces using selected |
| | | nonwoven core matrix bound | | construction equipment plus |
| | | between two geotextiles. | | diver assistance. |
| | | Reactive materials incorporated | | Can also be placed across exposed |
| | | into the product may include one | | (dry) sediment surfaces. |
| | | or more of activated carbon, | | Specific contaminants treated |
| | | coke, apatite and/or organoclays. | | by reactive mat (organics, |
| | | | | metals, etc.) are a function |
| | | | | of the reactive materials |
| | | | | included in the product. |
| | 3. Organoclay products | Manufactured, clay based product | No details provided. | Method for use (including |
| | (e.g. from Aqua | comprised of particles of | | placement) presumed to be similar |
| | Technologies of | bentonite (i.e. montmorillonite | | to that for AquaBlok ® products. |
| | Wyoming Inc.). | clay) modified to include | | Can also presumably be placed |
| | | quaternary amines within | | across exposed (dry) sediment |
| | | interstitial spaces of the clay | | surfaces. |
| | | mineral. | | Often used specifically for |
| | | Particles of relatively high | | hydraulic/chemical control of |
| | | specific gravity. | | seepage of NAPLs (non-aqueous |
| | | Product typically occurs as | | phase liquids). |
| | | pellets, granules or powder. | | |
| | 4. Phoslock ™ | Manufactured, clay based product | Described in Analytical & | Used to reduce the loss |
| | (all information | comprised of particles based on | Environmental Consultants, 2005. | (migration) of phosphorus from |
| | derived from | bentonite clay that has been | Per above reference, what | sediment into the overlying water |
| | reference provided). | modified by the addition of | appears to be a final step in | column through the formation of |
| | | lanthanum | the manufacture process | relatively insoluble lanthanum- |
| | | Particles presumably of | comprises “Drying, followed | phosphate complexes (ppts.). |
| | | relatively high specific gravity. | by grinding or pelletization, | Method of placement unclear, but |
| | | Typically(?) occurs in pelletized | where appropriate, using a | presumed similar to that used for |
| | | or granular form. | variety of binding agents.” | AquaBlok ® and organoclay |
| | | Product can also be incorporated | | products (when in particle form) |
| | | into geotextile mats. | | and similar to that used for |
| | | | | reactive core mat (when in |
| | | | | geotextile-mat form). |
| | 5. Baraclear | Manufactured, clay based product | Described in Analytical & | Used to deliver alum to submerged |
| | (all information | comprised of particles based on | Environmental Consultants, 2005. | sediment surface, presumably for |
| | derived from | aluminum (alum) -modified | | phosphate control, similar to |
| | reference provided). | smectite. | | Phoslock ™. |
| | | Particles presumably of | | Method of placement unclear, but |
| | | relatively high specific gravity. | | presumed similar to that used |
| | | May occur in the form of pellets, | | AquaBlok ® and organoclay |
| | | briquettes, or tablets. | | products. |
| | 6. Bauxsol ™ | Manufactured product comprised of | Described in Analytical & | Used to control releases of |
| | (all information | particles of chemically and | Environmental Consultants, 2005. | phosphorous and/or metals from |
| | derived from | physically modified waste product | Per above reference, indicates | sediment, as a function of |
| | reference provided). | from the aluminum smelting | that “Bauxsol ™ reagents | product blend (similar to |
| | | industry (includes proprietary | are prepared by . . . drying, | Phoslock ™?). |
| | | environmental improvement | size grading, pelletizing, or | Method of placement unclear, but |
| | | products). | otherwise physically modifying | presumed similar to that used |
| | | Various compositions or blends of | the raw material or the blend | AquaBlok ® and organoclay |
| | | product available. | to suit particular applications. | products. |
| | | Particles presumably of | | |
| | | relatively high specific gravity. | | |
| | | Product can occur as graded or | | |
| | | pelletized particles, as needed. | | |
| | 7. AlgalBLOCK | Manufactured product comprised of | No details provided, other than | Method of placement involves |
| | (all information | particles of a specialized form | a water slurry of the powder can | adding dry powder or water slurry |
| | derived from | or surface-activated, | be prepared prior to placement. | to water column. |
| | reference provided). | precipitated calcium carbonate. | | Product adsorbs dissolved |
| | | Product in powdered form. | | phosphorous during descent |
| | | | | through the water column. |
| | | | | Once settled to a submerged |
| | | | | sediment surface, product forms |
| | | | | a reactive barrier, or blanket, |
| | | | | which prevents further release of |
| | | | | phosphorous from sediments, |
| | | | | through the formation of |
| | | | | relatively insoluble hydroxy |
| | | | | apatite complexes (ppts.). |
| | 8. Ocher pellets | Manufactured product comprised of | No details provided. | Product particles placed through |
| | (also called | pellet-shaped particles | | water column and settles across |
| | limnomedicine) | consisting of ocher and calcium nitrate. | | submerged sediment surface. |
| | | Particles appear to be | | Designed to control release of |
| | | approximately gravel-sized (from | | phosphorous from underlying |
| | | photograph in reference | | sediments into overlying water |
| | | provided). | | column. |
| | | Specific gravity of pellets not | | |
| | | provided. | | |
| | 9. Activated carbon | Adsorbent particles derived from | No details provided. | See Table 1 herein for |
| | (AC), including | carbonaceous raw material, in | | contaminants targeted for |
| | granular activated | which thermal or chemical means | | cap-based treatment using this |
| | carbon (GAC). | have been used to remove most of | | product. |
| | | the volatile non-carbon | | Relative low specific gravity |
| | | constituents and a portion of the | | and/or fine-grained nature of |
| | | original carbon content, yielding | | product often precludes effective |
| | | a structure with high surface | | settling through a water column, |
| | | area. | | as is possible with, for example, |
| | | Particles are of relatively low | | more dense AquaBlok ® and |
| | | specific gravity. | | organoclay products. |
| | | Range of particle sizes | | Placement instead often involves |
| | | available, e.g. silt to sand | | forming a water slurry of the |
| | | sized. | | product and conveying the slurry |
| | | | | to a submerged sediment surface |
| | | | | by pumping or with a tremie pipe. |
| | | | | Bioturbation activity of benthic |
| | | | | organisms sometimes relied upon |
| | | | | to further incorporate the placed |
| | | | | product into the contaminated |
| | | | | sediment mass (technically |
| | | | | resulting in in situ treatment |
| | | | | rather than active sediment |
| | | | | capping). |
| Materials | 1. Blend of AC or | Self explanatory. | Commonly available construction | See Table 1 herein for |
| | GAC with sand. | Blend can be composed of variable | equipment typically used to | contaminants targeted for |
| | | percentages of component | blend component materials | cap-based treatment using this |
| | | materials. | together on shore or on | material. |
| | | Specific gravity of material | material barge. | Blend or slurry of blend |
| | | particles varies as a function of | May also form a water slurry of | typically placed through a water |
| | | material composition. | the dry material blend. | column in a manner similar to |
| | | | | that for placement of AquaBlok ® |
| | | | | and organoclay products. |
| | | | | Some degree of differential |
| | | | | settling of AC/GAC versus the |
| | | | | sand could be expected as a |
| | | | | function of differences in |
| | | | | specific gravity and/or sizes of |
| | | | | material particles. |
| | 2. Organic-rich soil | Self explanatory. | Material blends prepared similar | Typically intended for cap-based |
| | or sediment (with | Blends of soil or sediment with | to method for Material 1. | treatment (enhanced sorption) of |
| | or without blending | sand can be composed of variable | | migrating organic contaminants. |
| | with sand). | percentages of component | | Also intended as benthic habitat. |
| | | materials. | | Placement method typically |
| | | Specific gravity of material | | similar to that for Material 1. |
| | | particles varies as a function of | | Some degree of differential |
| | | material composition. | | settling of organic material |
| | | | | versus the sand could be expected |
| | | | | as a function of differences in |
| | | | | specific gravity and/or sizes of |
| | | | | material particles. |
| | 3. Apatites | Particles of naturally occurring | Not applicable. | Method for use (including |
| | (calcium | apatite mineral(s). | | placement through the water |
| | phosphates). | Particles are of relatively high | | column) similar to that used for |
| | | specific gravity. | | other “loose” (particle-based) |
| | | Particles typically granular in | | products or materials described |
| | | nature, but can occur as, or be | | above. |
| | | processed into, a gradation of | | Creates a relatively permeable |
| | | particle sizes. | | active cap. |
| | | | | Used for cap-based treatment of |
| | | | | migrating metallic contaminants. |
| | 4. Zeolites | Particles of naturally occurring | Not applicable for un-modified | Similar to material 3 |
| | (framework | (or chemically modified) zeolite | zeolites. | May also be used in cap-based |
| | silicates). | mineral(s). | No details provided for method | treatment of other (non-metallic) |
| | | Particles are of relatively high | for preparation of modified | cation pollutants. |
| | | specific gravity. | zeolites. | |
| | | Particles can occur, or be | | |
| | | processed into, a range of | | |
| | | particle sizes (e.g. silt to | | |
| | | gravel size). | | |
| | 5. Bauxite | Material comprised of particles | Not applicable. | Similar to material 3. |
| | (an aluminum ore). | containing varying proportions of | | Used for cap-based treatment of |
| | | aluminum and iron oxides. | | metallic contaminants. |
| | | Particles are of relatively high | | |
| | | specific gravity. | | |
| | | Material can occur, or be | | |
| | | processed into, a range of | | |
| | | particle sizes (e.g. silt to | | |
| | | gravel sized). | | |
| | 6. Clay rich in | No additional information | Not applicable. | No details provided regarding |
| | Fe oxides/ | available. | | method of use, including |
| | hydroxyoxides | | | placement. |
| | | | | Reference provided focuses on |
| | | | | cap-based treatment of |
| | | | | sediment-borne arsenic. |
| | | | | Additionally, Fe oxides/ |
| | | | | hydroxyoxides known for forming |
| | | | | relatively stable complexes with |
| | | | | a number of minerals. |
| | 7. Zero valent | Material comprised of particles | Not applicable. | No details provided regarding |
| | metal, ZVM, | of metal filings (or similar | | method of use, including |
| | particles (e.g. | material) of different elemental | | placement. |
| | iron, agnesium, | composition. | | Table 1 herein describes specific |
| | palladium). | Particles are of relatively high | | contaminants treated by one |
| | | specific gravity. | | common, ZVM, i.e. zero valent |
| | | Material can occur, or be | | iron (ZVI). |
| | | processed into, a range in | | |
| | | particle sizes (e.g. nano-scale | | |
| | | to sand-sized). | | |

| | | Known patents (P) or | |
|---|---|---|---|
| Name of product or material | | published applications (A) | Selected references |
| Products | 1. AquaBlok ® | P U.S. Pat. No. 5,538,787 (USA) | www.aquablokinfo.com |
| | products (from | P U.S. Pat. No. 5,897,946 (USA) | www.adventusgroup.com |
| | AquaBlok, Ltd). | P U.S. Pat. No. 6,386,796 (USA) | Vogan et al., 2007 |
| | | P U.S. Pat. No. 6,558,081 (USA) | Bullard et al., 2007 |
| | | P U.S. Pat. No. 7,011,766 (USA) | http://www.hsrc- |
| | | | ssw.ors/ana-index.html |
| | 2. Reactive Core | A 20050103707 (USA) | www.cetco.com (see |
| | Mat ® products | A 20060000767 (USA) | “remediation technologies”, |
| | (from CETCO). | A 20060286888 (USA) | “Reactive Core Mat ®”) |
| | | A 20070059542 (USA) | McDonough et al., 2006 |
| | | | http://www.hsrc- |
| | | | ssw.org/ana-index.html |
| | 3. Organoclay products | | www.aquatechnologies.com/projects_sedimentcap.htm |
| | (e.g. from Aqua | | Alther, 2007 |
| | Technologies of | | Reible et al., 2007 |
| | Wyoming Inc.). | | Knox and Paller, 2007 |
| | 4. Phoslock ™ | A US patent reported to | Analytical & Environmental |
| | (all information | exist, but no number | Consultants, 2005 |
| | derived from | available. | |
| | reference provided). | | |
| | 5. Baraclear | US 2003/0213753 A1 | Analytical & Environmental |
| | (all information | | Consultants, 2005 |
| | derived from | | |
| | reference provided). | | |
| | 6. Bauxsol ™ | | Analytical & Environmental |
| | (all information | | Consultants, 2005 |
| | derived from | | |
| | reference provided). | | |
| | 7. AlgalBLOCK | | Analytical & Environmental |
| | (all information | | Consultants, 2005 |
| | derived from | | |
| | reference provided). | | |
| | 8. Ocher pellets | | Park et al., 2007 |
| | (also called | | |
| | limnomedicine) | | |
| | 9. Activated carbon | | Ghosh, 2006 |
| | (AC), including | | Norge Dagbladet, |
| | granular activated | | August 2007 |
| | carbon (GAC). | | |
| Materials | 1. Blend of AC or | | Cornelissen et al., 2006 |
| | GAC with sand. | | |
| | 2. Organic-rich soil | | Alcoa, Inc., 2002 |
| | or sediment (with | | BBL, 2006 |
| | or without blending | | |
| | with sand). | | |
| | 3. Apatites | P U.S. Pat. No. 6,290,637 (USA) | http://www.hsrc- |
| | (calcium | | ssw.org/ana-index.html |
| | phosphates). | | Melton et al., 2007 |
| | | | Crannell et al., 2004 |
| | 4. Zeolites | | Jacobs and Forstner, 1999 |
| | (framework | | Jacobs and Waite, 2003 |
| | silicates). | | Knox and Paller, 2007 |
| | 5. Bauxite | Indicated as “patent pending” | Gavaskar et al., 2005 |
| | (an aluminum ore). | in Gavaskar et al. reference | Melton, 2005 |
| | | provided. | |
| | 6. Clay rich in | | Chattopadhyay et al., 2007 |
| | Fe oxides/ | | |
| | hydroxy-oxides | | |
| | 7. Zero valent | | Lowry et al., 2003 |
| | metal, ZVM, | | Annonymous, 2003 |
| | particles (e.g. | | Melton, 2005 |
| | iron, agnesium, | | |
| | palladium). | | |

AquaBlok® products have also been described in EP A2 1,710,025 and US 2007/0113756. CN 1927747 describes a product that appears to be a direct imitation of AquaBlok. All of these products are described as having a “core” coated with another layer and hence describe a compositionally non-homogenous material. The present invention involves neither a core nor material layering, and hence each particle of the present invention is more-or-less compositionally uniform in terms of spatial distribution of materials contained therein (please see “particle” in detail of FIG. 2b).

KR 100574025B also describes a presumably granular and/or pelletized product, similar to AquaBlok, This product involves manufacturing steps of “shaping” or “molding”. The present invention involves neither manufacturing step.

US 2007/0025820 describes a product comprising “fibrous organic matter” and “multivalent metal”. The present invention includes neither material component.

In summary, all of the above-noted products are clearly different from the present invention in terms of compositional homogeneity; steps involved in manufacture; and/or composition.

### 4b. Comparisons with the Invention

Various aspects of the invention can be compared with (and amongst) the listed products or materials and methods for creating active capping layers. A summary of such aspect-specific comparisons, including an identification of apparent similarities as well as apparent differences, is provided below.

### With Respect to Intended Function and Use

The other listed products and materials are also designed or intended to treat mobilized, sediment-borne contaminants within the context of the concept of active capping, as the concept is defined and described herein.

Although not explicitly stated for all products, particles of most products—including the invention—likely undergo some type of significant “phase change” upon particle contact with water: that is, relatively rapid, partial to complete destruction of the initial particle structure or form likely occurs through the processes of hydration, swelling, disaggregation and/or crumbling. Two exceptions to this would be products 2 and 9, which would remain in-tact, over the long-term, upon contact with water. NOTE: Except for product 1, no other product explicitly states that such a phase change occurs as product particles are wetted, or that such a phase change is, in fact, integral to effective functioning and use of the product (i.e. ultimate formation of a homogeneous active capping layer).

Only one other product (product 1) explicitly states that the permeability of the sediment cap or barrier formed using the product can be controlled or modified as a function of the materials included therein.

Only one other product (product 1) explicitly states that it can be selectively formulated for and applied into fresh, brackish or full-strength seawater environments. The option of selective formulation and use of other products in such different aquatic environments is unclear.

### With Respect to Composition and Physical Character

With the exception of product 2 (reactive core mats), all listed products and materials are, like the invention, comprised of particles, which are placed in bulk to form an active capping layer across the sediment surface.

Although not explicitly stated for all products, most product particles—including those of the invention—are likely of a relatively dry and solid nature in their pre-placed form.

Most products and materials are or can be, like the invention, of a relatively high specific gravity, i.e. ˜2 g/cm³ or higher. In contrast, the “apparent density” of activated carbon products is typically well below 1 g/cm³, and the specific gravity of organic components of organic-rich soil or sediment is typically well below 2 g/cm³. Also, note that the specific gravity of many clay based products or materials (e.g. products 3, 4, and 5; material 6) will vary not only as a function of the specific gravity of the key clay mineral or oxide component(s) present, but also as a function of other factors (moisture content, porosity, degree of mineral packing into the particle, etc.).

Excluding product 2, only the invention and product 1 seem to include the reactive material as one of several material components, whereby the product particles are essentially acting to deliver the reactive material to the sediment surface, and whereby the additional components present are typically serving only to facilitate this delivery process. In contrast, all other product particles appear to be solely comprised of the reactive material itself (e.g. products 3, 4, 5 and 9).

The shape/form of particles of the invention are irregularly shaped, sub-angular to plate-like, solid particles. In contrast, the shape/form of other products' particles (excluding product 2) is highly variable, and includes semi-round, pelletized, granular and/or powdered particles.

Only a couple other products (product 1 and perhaps also product 6) can selectively comprise particles of substantially different sizes and size gradations (i.e. ranging from mm- to cm-scale). For other products, the level of control over the size and size gradation of the particles (pellets, granules, briquettes, tablets, etc.) is less clear, and may be limited by respective procedures for manufacture. In contrast to these other products, significant control over such attributes is, in fact, probably possible for many of the listed materials, particularly the mineral- or ore-based materials (materials 3, 4 and 5).

A number of the products include or can selectively include, like the invention, as a key component montmorillonite clay or some mineralogic/geologic “relative” thereof, i.e. smectite clay, bentonite (products 1, 3, 4 and 5).

A couple other products (products 1 and 2) may include, like the invention, multiple reactive materials, e.g. AC plus Fe oxides plus nutrients, for simultaneous cap-based treatment of multiple contaminants. In contrast, still other products (e.g. products 4, 5, 6 and 7) can only, or are designed to only, treat a single contaminant, e.g. phosphorous.

A couple other products (products 1 and 2) can alternatively include, like the invention, different reactive materials, e.g. AC or coke or organoclay or ZVI, to accomplish cap-based treatment of selected contaminants. In contrast, still other products can only, or are designed to only, treat a limited number/group of contaminants by virtue of limitations in the variety of reactive materials that can be incorporated into the product, e.g. as limited by the extent to which smectite clay can be chemically modified (products 3, 4, 5).

Only the invention explicitly and optionally allows for inclusion of relatively dense minerals (specific gravity of well over 3 g/cm³) such as barite, ilmenite, olivine and/or hypersthene as part of its compositional make-up. In this way, only particles of the invention can be significantly modified in terms of their specific gravity. As discussed below, this has direct implications with respect to the rate of particle settling and thus the overall success in product placement through the water column.

### With Respect to the Method of Product Manufacture

As described in Sections 2b and 3b, key steps in the manufacture of particles of the invention involve drying of a relatively flat mass of flowable paste (thus forming the “raw” and relatively large, solid material mass), followed by crushing the solid mass into smaller-sized (and more manageable) solid masses (which may then be optionally sieved into selected particle size fractions).

The method for manufacture of particles of the invention is clearly and significantly different from methods for respective manufacturing of products 1, 2 and 9.

Manufacture of products 3, 4, 5, 6 and 7 appear to include, as initial key steps, some type of chemical modification, which is not part of the process for manufacture of particles of the invention. Furthermore, subsequent, final to near-final, steps for manufacture of all of these products (plus product 8) appear to involve some type of material extrusion, molding and/or pulverizing step, as evidenced by the words “pellets”, “briquettes”, “tablets” or “powdered”. Such steps are not part of the procedure for manufacture of particles of the invention.

It may be concluded from the information provided that the procedure for manufacturing particles of the invention, which exclusively involves the following sequence of steps: material mixing to form a flowable paste→paste drying→crushing (but not pulverizing)→sieving (optional), with or without an additional optional drying step (post-crushing and/or post-sieving) is a unique procedure for manufacturing such particles.

The process for manufacturing particles of the invention also appears unique when compared to any of the processes generally described for manufacturing SediMite pellets, as described at the beginning of Section 4a.

### With Respect to Material Placement

### Material Placement Across Exposed (Dry) Sediment Surfaces:

Whether or not explicitly stated, all other products and materials can, like the invention, be placed in such environments using a variety of equipment and techniques.

### Material Placement Across Submerged Sediment Surfaces Through the Water Column:

All “loose”, or particle-based, capping products and materials can—in theory—be placed in bulk into water, like the invention, with the intention that the mass of particles descends through the water column and ultimately distributes (deposits) across the target sediment surface. However, the level of success² with which active capping products or materials can, in fact, be placed in a controlled and uniform manner will be highly dependent upon a variety of factors, including: ² “Success” in placing active capping products or materials through the water column in a controlled and uniform manner may be defined in various ways, including: layer thickness constructed as intended, with minimal “±” vertical variability; placement across intended footprint, with minimal lateral inaccuracies; minimal “stripping” losses of material or product to the water column during descent; vertically uniform distribution of reactive material throughout the placed layer; overall efficiency of the process; etc.
1. The chosen equipment and technique for placement, including the position of material release, e.g. above the water surface versus submerged release (close to the sediment surface, using, for example, a tremie pipe);
2. Cohesiveness of the material mass during its descent (which will control the extent to which the material laterally disperses during descent). Does the material more-or-less “stick together” and settle as a single, large mass? Or do material particles remain more-or-less separate, and settle more-or-less individually?
3. Settling characteristics of the material particles, as dictated by the inherent properties of specific gravity; size and size gradation; and stability or integrity of the particles (do the particles disaggregate or crumble apart during descent, or do they remain in-tact up to and past the point of material deposition?); and
4. Site conditions such as water depth and current flow, which will affect the extent of lateral dispersion of the material during its descent through the water column.

Additional issues related to the overall success of cap construction—which are not addressed above—include the short- and long-term responses of the capped sediment (e.g. re-suspension and mixing; consolidation; geotechnical stability; etc.) during and after the masses of capping product or material have been deposited.

The “art” of successfully placing conventional and active capping products and materials through the water column and across submerged sediment surfaces, towards the end-goal of constructing cap designs as intended (and in an environmentally protective manner), is a subject of great interest and study amongst sediment-management practitioners worldwide (e.g. McDonough et al, 2006; Palermo, 2004; SFT, 2006; Thompson et al., 2004; US ACE, 2005; Verduin, 2004). In fact, within the context of overall project success, many practitioners consider successful placement of active capping products and materials to be just as important as the demonstrated treatment effectiveness of the reactive material(s) included within the cap (e.g. as confirmed through controlled laboratory treatability testing).

Other factors being equal (i.e. factors 1, 2 and 4 above), optimal settling characteristics of active capping particles should typically be achieved when: (a) the particles are of a relatively high specific gravity (well above 2 g/cm³), which promotes relatively rapid settling (b) the particles are of a relatively coarse-grained nature (sand-sized or much larger) which also promotes relatively rapid settling; and (c) the particles remain in-tact during descent and deposition. The invention fits these criteria and thus should be able to be successfully placed through the water column.

Two of the products or materials listed in Table 2 that also clearly fit all of the criteria for optimal settling, and for which field-scale placement has already been successfully demonstrated, is the AquaBlok® technology (product 1) and apatite (material 3). Based on the same criteria for optimal settling, a number of other active capping products or materials also have the potential for successful placement through water columns, although the number of field-scale projects demonstrating effective placement of these other products or materials appears to be quite limited.

Conversely, active capping particles that do not fit all of the criteria for optimal settling should typically be more difficult to place successfully through the water column. Activated carbon and organic-rich soil or sediment would tend to fall into this category, because of their relatively low specific gravity and often fine-grained character. Challenges in effectively placing these reactive products or materials, either on their own or when blended with sand, have, in fact, been previously noted by other practitioners (e.g. McDonough et al., 2006; Reible, 2002; BBL, 2006).

In summary: the invention as well as all of the products and materials listed in Table 2 are designed or intended to accomplish essentially the same remedial goal: treatment of mobilized, sediment-borne contaminants within the context of the concept of active capping. In this fundamental way, then, the invention is not unique. The invention is also not unique from many of the products and materials in terms of: its particle-based nature; the manner in which bulk masses of particles can be placed across exposed or submerged sediment surfaces; the contaminants targeted for cap-based treatment; the reactive materials included or involved; or the processes/mechanisms by which cap-based treatment occurs.

The invention is, however, unique from nearly all—if not all—other active capping products or materials in a number of important ways, as summarized below.

Invention Uniqueness with Respect to Intended Function and Use

The occurrence of a significant phase change upon contact of dry particles of the invention with water (i.e. transformation from solid to disaggregated material) is explicitly stated as integral to effective functioning and use of the invention, i.e. the ultimate formation of a compositionally homogenous active capping layer.

The permeability of a sediment cap or barrier formed using the invention can be controlled or modified as a function of the materials included in the product.

Particles of the invention can be selectively formulated for and applied into fresh, brackish or full-seawater environments.

Invention Uniqueness with Respect to Composition and Physical Character

Particles of the invention include reactive material as one of several material components, rather than being solely comprised of such reactive material.

The shape/form of particles of the invention are irregularly shaped, sub-angular to plate-like particles.

The invention can selectively comprise particles of substantially different sizes and size gradations (as a function of the manufacture procedure) as well as particles of different specific gravity (as a function of optionally including relatively dense minerals).

The invention can optionally include multiple reactive materials for simultaneous cap-based treatment of multiple contaminants.

Invention Uniqueness with Respect to the Method of Product Manufacture

The process for manufacturing particles of the invention exclusively involves the following sequence of steps: material mixing to form a flowable paste→paste drying→crushing (but not pulverizing)→sieving (optional), with or without an additional optional drying step (post-crushing and/or post-sieving).

Invention Uniqueness with Respect to Material Placement

By virtue of flexibility in their composition and method for manufacture, particles of the invention can possess characteristics that are optimal for product settling through the water column (relatively high specific gravity, relatively large particle size and relatively high integrity). Thus, the potential for successful placement of masses of the particles across submerged sediment surfaces is also optimized.

### 4c. Improvements of the Invention Over Existing Products or Materials and Methods

Various unique aspects of the invention are summarized above. As also described above, many of these unique aspects represent significant improvements over existing products or materials and methods for creating active sediment caps (i.e. active capping layers).

In brief, the invention is a unique and versatile product that should be at least as successful as existing (and competing) products and materials in terms of providing for cost-effective as well as technically effective active capping of contaminated sediments.

### 5. REFERENCES

BBL. 2006. Bench-scale study report for Silver Lake sediments. Prepared for General Electric Company. March, 2006.
Coates, J., J Woodward, J. Allen, P. Philp and D. Lovley. 1997. Anaerobic degradation of polycyclic aromatic hydrocarbons and alkanes in petroleum-contaminated marine harbor sediments. Applied and Environmental Microbiology: pp. 3589-3593.
Crannell, B., T. Eighmy, C. Willson, D. Reible and M. Yin. 2004. Pilot-Scale Reactive Barrier Technologies for Containment of Metal-Contaminated Sediments and Dredged Materials. A Final Report Submitted to: The NOAA/UNH Cooperative Institute for Coastal and Estuarine Environmental Technology (CICEET). November 2004.
Eggen, T. and A. Majcherczyk. 2006. Effects of zero-valent iron (Fe0) and temperature on the transformation of DDT and its metabolites in lake sediment. Chemosphere, Vol. 62: pp. 1116-1125.
Envisan. 2005a. Development of an integrated approach for the removal of tributyltin (TBT) from waterways and harbors: Prevention, treatment and reuse of TBT contaminated sediments, Task 3551—Remediation of Sediments: Treatment of the aqueous phase. LIFE02 ENV/B/000341. Available on the web.
Envisan. 2005b. Development of an integrated approach for the removal of tributyltin (TBT) from waterways and harbors: Prevention, treatment and reuse of TBT contaminated sediments, Task 3550—Remediation of Sediments: Treatment of the solid phase. LIFE02 ENV/B/000341. Available on the web.
Field, R. 2001. Review of scientific literature on microbial dechlorination and chlorination of key chlorinated compounds, 3rd Quarterly Report, 3rd Quarter Year 2001. Report prepared for EUROCHLOR. November 2001.
Gardner, K., E. Hadnagy, D. Aulisio and J. Spear. 2004. In-situ dechlorination of polychlorinated biphenyls in sediments using zero-valent iron. Benchmarking workshop for sediment and floodplain remediation, Mar. 25-26, 2004, University of Michigan, Ann Arbor.
Ghosh, U., R. Luthy, J. Zimmerman, P. McLeod, D. Smithenry, T. Bridges and R. Millward. 2004. In situ stabilization of persistent organic contaminants in sediments using activated carbon technology. Benchmarking workshop for sediment and floodplain remediation, Mar. 25-26, 2004, University of Michigan, Ann Arbor.
Golder Associates. 2003. Limnofix in-situ sediment treatment technology. White paper. April 2003.
Gullick, R. and W. Weber. 2001 or later. Shale as a sorbent additive to increase containment barrier efficiency. No details (available on the web).
Hyun, S., C. Jafvert, L. Lee, P. Suresh and C. Rao. 2006. Laboratory studies to characterize the efficacy of sand capping a coal tar-contaminated sediment. Chemosphere 63: pp 1621-1631.
Häggblom, M. 2004. In-situ enhancement of anaerobic microbial dechlorination of polychlorinated dibenzo-p-dioxins and dibenzofurans in marine and estuarine sediments. Remediation Technologies Development Forum (RTDF) workshop, Baltimore, Md., Feb. 18-19, 2004.
Interstate Technology & Regulatory Council Permeable Reactive Barriers Team. 2005. Permeable reactive barriers: Lessons learned/new directions. February 2005.
Jacobs, P. and U. Förstner. 1999. Concept of subaqueous capping of contaminated sediments with active barrier systems (ABS) using natural and modified zeolites. Water Research, Vol. 33, Issue 9: pp. 2083-2087.
Jacobs, P. and T. Waite. 2004. The role of aqueous iron(II) and manganese(II) in sub-aqueous active barrier systems containing natural clinoptilolite. Chemosphere, Vol. 54: pp. 313-324.
Kao, C., S. Chen, J. Liu and M. Wu. 2001. Evaluation of TCDD biodegradability under different redox conditions. Chemosphere, Vol. 44, Issue 6: pp. 1447-1454.
Layman's Report. 2005. Development of an integrated approach for the removal of tributyltin (TBT) from waterways and harbors: Prevention, treatment and reuse of TBT contaminated sediments. LIFE02 ENV/B/000341. Available on the web.
Lowry, G. and K. Johnson. 2004. Congener-specific dechlorination of dissolved PCBs by microscale and nanoscale zero-valent iron in a water/methanol solution. Environ. Sci. Technol. Vol. 38: pp. 5208-5216.
McDonough, K., P. Murphy, J. Olsta, Y. Zhu, D. Reible and G. Lowry. 2006. Development and Placement of a Sorbent-amended Thin Layer Sediment Cap in the Anacostia River. International Journal of soil and sediment contamination (accepted for publication).
Messing, A., L. Ramirez and T. Fox. 1997. A review to determine state-of-the-practice treatment technologies for reducing concentrations of organotin compounds in wastewater. No details (available on the web).
Mikszewski, A. 2004. Emerging technologies for the in situ remediation of PCB-contaminated soils and sediments: Bioremediation and nanoscale zero-valent iron. Prepared by National Network for Environmental Management Studies Fellow for U.S. Environmental Protection Agency. August 2004.
Miralles, G., V. Grossi, M. Acquaviva, R. Duran, J. Bertrand and P. Cunya. 2007. Alkane biodegradation and dynamics of phylogenetic subgroups of sulfate-reducing bacteria in an anoxic coastal marine sediment artificially contaminated with oil. Chemosphere, in press.
Mitchell, D., R. Swannell, G. Kjeilen, S. Ramstad, O. Brakstad and S. Cripps. 2000. Final UKOOA Project 4.1—Acceleration of natural degradation. AEAT/ERRB/ED12049/R/001-Issue 3, January 2000.
Millward, R., T. Bridges, G. Lotufo, R. Luthy, J. Zimmerman and U. Ghosh. 2005. Use of carbon sorbents to reduce contaminant bioavailability in sediments. Paper C2-01, In: R. F. Olfenbuttel and P. J. White (Eds.), Remediation of Contaminated Sediments—2005: Finding Achievable Risk Reduction Solutions. Proceedings of the Third International Conference on Remediation of Contaminated Sediments, New Orleans, La., Jan. 24-27, 2005.
Palermo, M. 2004. Cap implementation. In: Proceedings of EPRI-sponsored workshop on in-situ contaminated sediment capping, Cincinnati Ohio, May 12-14, 2003.
Palermo, M., S. Maynord, J. Miller and D. Reible. 1998. Guidance for in situ subaqueous capping of contaminated sediments. Assessment and remediation of contaminated sediments (ARCS) program, Great Lakes National Program Office, US PA 905-B96-004.
Reible, D. 2002. In Situ Sediment Remediation Through Capping: Status and Research Needs. Publication available at www.sediments.org.
Rockne, K. and K. Reddy. 2003. Bioremediation of contaminated sites. Invited theme paper, international e-conference on modern trends in foundation engineering: Geotechnical challenges and solutions, Indian Institute of Technology, Madras, India, October 2003.
Rockne, K. and R. Makkar. 2001. Anaerobic electron acceptor amendment for aromatic pollutant biodegradation in sediments. In Situ and On Site Bioremediation. Vol. 6, No. 5: pp 297-304.
Rothermich, M., L. Hayes and D. Lovley. 2002. Anaerobic, Sulfate-Dependent Degradation of Polycyclic Aromatic Hydrocarbons in Petroleum-Contaminated Harbor Sediment. Environ. Sci. Technol. Vol. 36: pp. 4811-4817.
SFT, 2002. Tildekking av forurensede sjøsedimenter, TA-1865/2002
SFT, 2006. Veiledende testprogram for masser til bruk for tildekking av forurensede sedimenter. TA-2143/2005
Thompson, T. G. Hartman, C. Houck, J. Lalley, and R. Paulson. 2004. Methods and considerations for cap design, contracting, construction, and monitoring over soft, unconsolidated sediments. In: Proceedings of EPRI-sponsored workshop on in-situ contaminated sediment capping, Cincinnati Ohio, May 12-14, 2003.
U.S. Environmental Protection Agency (US EPA). 2005. Contaminated sediment remediation for hazardous waste sites. Office of Solid Waste and Emergency Response, OSWER 9355.0-85, EPA 540-R-05-012. December.
U.S. Army Corps of Engineers (US ACE). 1998. Guidance for subaqueous dredged material capping. Technical Report DOER-1. June.
US ACE. 2005. Equipment and placement techniques for subaqueous capping. ERDC TN-DOER-R9. September.
Verduin, J. 2004. Determining cap placement requirements on soft sediments. In: Proceedings of EPRI-sponsored workshop on in-situ contaminated sediment capping, Cincinnati Ohio, May 12-14, 2003.
Werner, D., C. Higgins and R. Luthy. 2005. The sequestration of PCBs in Lake Hartwell sediment with activated carbon. Water Research, Vol. 39: pp. 2105-2113.
Zimmerman, J., D. Werner, U. Ghosh, R. Millward, T. Bridges and R. Luthy. 2005. Effects of dose and particle size on activated carbon treatment to sequester polychlorinated biphenyls and polycyclic aromatic hydrocarbons in marine sediments.
   Environmental Toxicology and Chemistry, Vol. 24, No. 7: pp. 1594-1601.”

1. A product for creating an active capping layer across submerged surfaces of contaminated sediment, characterized in that it comprises dry particles, wherein each dry particle is composed of three different materials viz. inert material, reactive material and binding material, which are more-or-less evenly distributed spatially throughout the mass of each particle; with said particles having high integrity and strength, and with said particles displaying variable and controllable characteristics of particle shape, size, size gradation and specific gravity.

2. A product according to claim 1 wherein the three different materials are composed of variable types and amounts of:
inert material selected from:
clay to silt-sized fractions of one or more of the following relatively non-reactive and relatively dense minerals:
bentonite (of a sodium- and/or calcium-rich character); dolomite; calcite; barite; ilmenite; hypersthene; olivine and magnetite; or
sand-sized fractions of one or more of the following relatively non-reactive and relatively dense minerals: quartz-rich sand (containing a mixed-mineral assemblage); dolomite; calcite; ilmenite; hypersthene; magnetite and olivine;
reactive material selected from:
a) materials in solid form including one or more of the following, which occur in a range of size fractions (clay to sand-sized) and in a range of particle densities: activated carbon; coke; organic-rich topsoil; organic-rich sediment; humus; apatite; zeolite; iron ore-rich material; organoclay; organic shale; lime; gypsum; elemental sulphur; bauxite; fish meal; zero-valent iron (ZVI); oxides/hydroxyoxides of iron, manganese and aluminum; products rich in nutrients and molecular oxygen; and
b) materials in liquid form including one or more of the following: biosurfactants; liquid fertilizer; hydrogen peroxide and potassium permanganate; products rich in nutrients and molecular oxygen; and
multiple reactive materials: activated carbon plus Fe oxides plus nutrients; and
binding material of
a) an organic character, and occurring in solid or liquid phase, selected from polyvinyl acetate; hydroxyethyl cellulose; guar gum and guar derivatives; or
b) an inorganic character, and occurring in solid or liquid phases, selected from glass fibers; gypsum and silicates of sodium, potassium and lithium.

3. Particles according to claim 1, wherein the dry particles occur as irregularly shaped, sub-angular to plate-like solid masses of variable sizes ranging from 0.5 cm in equivalent diameter up to 4 cm in equivalent diameter.

4. Particles according to claim 1, wherein the density, or specific gravity, of the dry particles ranges from 2 g/cm³ up to 4 g/cm³.

5. Particles according to claim 1, wherein the dry particles have a unit weight (bulk density) ranging from 80 pounds per cubic foot (lbs/ft³) up to 150 lbs/ft³.

6. A method for manufacturing particles described in claim 1 involving implementing the sequential steps of: mixing dry plus liquid materials into a flowable paste; placing the paste as a flat and thin layer; drying the paste into relatively large, solid masses by natural and/or accelerated means; crushing the relatively large masses into relatively smaller masses (particles) and optionally sieving the particles into variable and controllable ranges of sizes.

7. Method according to claim 6 comprising the following steps:
a. appropriate quantities of selected inert, reactive and binding materials (all materials in dry form) are physically mixed together into a compositionally homogenous, dry blend;
b. the dry blend of materials is physically mixed together with an appropriate quantity of clean water as well as quantities of selected reactive material (in liquid form, if present) plus selected binding material (in liquid form, if present) for the purpose of forming a compositionally homogeneous and flowable paste;
c. the paste is placed onto a flat surface, in a manner that maximizes paste surface area while maintaining a paste thickness of approximately 1 to 2 cm;
d. the paste is allowed to dry by one of several means, or by a combination of means;
e. the dried material—which typically forms relatively large and flat, “plate-like” masses—is physically crushed into smaller-sized masses by one of several means;
f. the material is optionally partitioned into selected particle size fractions or size-fraction ranges by mechanical sieving; and
g. masses of the dry particles may then either be packaged into water-resistant bags or stockpiled in bulk, in a manner that protects the bulk material from contact with water.

8. Use of particles described claim 1 for creating an active capping layer across submerged surfaces of contaminated sediments in water involving placing masses of such particles above said sediments to form a layer of deposited particles; said particles subsequently undergoing a relatively rapid and significant phase change upon contact with water to form disaggregated material and a compositionally homogeneous active capping layer.

9. Use according to claim 8, wherein the permeability, or saturated hydraulic conductivity, of the active capping layer formed from the particles ranges from the order of 10⁻² cm/s up to on the order of 10⁻⁸ cm/s.

10. Use according to claim 8, wherein the capping product comprises activated carbon, a 50/50 blend of dolomite and bentonite, and polyvinylacetate having dry particle sizes ranging from 0.5 to 2.0 cm and an average particle density of 2.5 g/cm³.

11. Use according to claim 10, wherein the sediment being capped with the capping product is contaminated with TBT.

12. Use according to claim 8, wherein the capping product comprises gypsum and N+P fertilizer, a 50/50 blend of barite and quartz-rich sand, polyvinyl acetate with dry particle product range of 1.5 to 3.0 cm and an average particle density of more than 3 g/cm³ and wherein the capping layer displays a permeability of 10⁻⁴ to 10⁻⁵ cm/s.

13. Use according to claim 12, wherein the sediment being capped with the capping product is contaminated with hydrocarbons including aliphatic hydrocarbons and low-ring polycyclic aromatic hydrocarbons.
